(19) United States
(12) Patent Application Publication
(10) Pub. No.: US 2010/0247419 A1
(43) Pub. Date: Sep. 30, 2010

(54) SOLID PHASE SYNTHESIZED CARBON NANO FIBER AND TUBE

(76) Inventor: Khe C. Nguyen, Ho Chi Minh City (VN)

Correspondence Address: QUARLES & BRADY LLP, RENAISSANCE ONE, TWO NORTH CENTRAL AVENUE, PHOENIX, AZ, 85004-2391, US

(21) Appl. No.: 11/555,363

(22) Filed: Nov. 1, 2006

(51) Int. Cl. D01F 9/12; C01B 31/02

(52) U.S. Cl. 423/447.2; 423/445 R; 977/700; 977/742; 977/750; 977/752; 977/842; 977/843

(57) ABSTRACT

A carbon nano tube characterized by Bragg diffraction pattern peaks appearing at 2 theta (2θ)=26.5°, 44.5°, 51.8°. A carbon nano fiber is disclosed and characterized by Bragg diffraction pattern peaks appearing 2 theta (2θ)=44.5°, 51.8°. These carbon nano materials can be prepared in a solid phase by combustion and heating of the solid raw materials both with and without a tube control agent. The carbon nano tube growth process can include controlling the length of the tubes.

### FIELD OF INVENTION

This invention relates to nano technology, and more particularly relates to a carbon nano fibers and tubes.

### BACKGROUND

Because of their unique structure, physical and chemical properties the recently discovered carbon nano-tube (Multi-Walled Carbon Nano Tube(MWCNT) and Single-Walled Carbon Nano-Tubes—SWCNT) materials have been investigated for many applications. Indeed this is one material from which the application development has out-paced its mass availability. The most added-value applications that are being developed using nano tubes include Field Emission Devices, Memory devices (high-density memory arrays, memory logic switching arrays), Nano-MEMs (Micro Electrical Mechanical systems), Atomic Force Microscope (AFM) imaging probes, distributed diagnostics sensors, and strain sensors. Other key applications include: thermal control materials, super strength (100 times steel) and light weight reinforcement and nano composites, Electromagnetic Interference (EMI) shielding materials, catalytic support, gas storage materials, high surface area electrodes, and light weight conductor cable and wires.

Carbon fibers and whiskers, both of which are carbon forms other than nano tubes, have been synthesized for many decades, and have revolutionized structural materials in almost every application where lightweight and high strength are desirable qualities. Much smaller than fibers or whiskers, carbon nano tubes were discovered only recently.

Techniques that have been developed to produce nano tubes in sizeable quantities include arc discharge, laser ablation, high pressure carbon monoxide (HiPCO), and chemical vapor deposition (CVD). Of these, the CVD method has shown the most promise in terms of its price/unit ratio. The CVD method generally involves reacting a carbon-containing gas (such as acetylene, ethylene, ethanol, etc.) with a metal catalyst particle (usually cobalt, nickel, iron or a combination of these such as cobalt/iron or cobalt/molybdenum) at temperatures above 600° C. Solid phase synthesis of carbon nano tubes has been known through two techniques: arc discharge and laser ablation each of which will be discussed in what follows.

Carbon nano tube (CNT) synthesis is known by a process of arc discharge. An electric arc is an electrical breakdown of a gas which produces an ongoing plasma discharge, similar to the instant spark, resulting from a current flowing through normally nonconductive media such as air. An archaic term is the voltaic arc as used in the phrase “voltaic arc lamp”. The various shapes of electric arc are emergent properties of nonlinear patterns of the current and the electric field. The arc occurs in the gas-filled space between two conductive electrodes (often made of carbon) and results in a very high temperature, capable oz melting or vaporizing virtually anything. In the arc discharge process, a carbon anode loaded with catalyst material (typically a combination of metals such as nickel/cobalt, nickel/cobalt/iron, or nickel and transition element such as yttrium) is consumed in the arc plasma. The catalyst and the carbon are vaporized, and the SWCNT material is grown by the condensation of carbon onto the condensed liquid catalyst. Sulfur compounds such as iron sulfide, sulfur or hydrogen sulfides are typically used as catalyst promoter to maximize the SWCNT material yield.

When using the existing method based on arc discharge, it is difficult to increase the amount of vaporized carbon, and it is difficult to control the process parameters of the arc. In the arc the carbon rods act as the feed materials and the source (electrodes) for arc discharge. Accordingly, it is difficult to control separately these functions. This results in limited production of carbon nano tubes and in a product that is highly contaminated with other clustered carbon materials, causing the high cost of mass production. The cost of SWCNT material is determined by production rate, yield, and raw materials cost. The raw materials consist of a carbon source, a catalyst, and promoters. Current modes of SWCNT material production involve the use of catalyst-packed graphite rods which are consumed in a DC electric arc to produce soot that contains SWCNT material.

A variation of the packed rod technique has also been developed and utilizes the catalyst as a molten metal in a small crucible onto which a graphite rod is arced, thereby co-vaporizing carbon and catalyst to form several grams of SWCNT material per operation. The product of the arc-based production methods contains SWCNT material that is coated with amorphous carbon, as well as with other contaminants including amorphous and graphitic carbon particles, carbon-coated metal catalyst particles, and traces of fullerenes-C.sub.60, C.sub.70, etc. Separation schemes have been devised to remove the contaminant which allow limited (one tenth of one percent ( 1/10th %)) recovery of pure carbon nano tubes. Relatively pure SWCNT material has been produced others who have investigated the production of SWCNT material from untreated bituminous coal have shown that SWCNT material can be produced, but with twofold to fourfold reduction in the purity, that transition metal impurities, such as pyrite in bituminous coal, may contribute a synergistic catalytic effect, and that it might be possible to produce SWCNT material from pyrite rich bituminous coal without adding any catalyst. However, the presence of sulfur dramatically decreases the yield.

Carbon nano tube (CNT) synthesis has been known by laser ablation by using a laser to ablate a composite block of graphite mixed with catalytic metal. The catalytic metal can include Co, Nb, Pt, Ni, Cu, or a binary combination thereof. The composite block is formed by making a paste of graphite powder, carbon cement, and the metal. The paste is next placed in a cylindrical mold and baked for several hours. After solidification, the graphite block is placed inside an oven with a laser pointed at it, and Ar gas is pumped along the direction of the laser point. The oven temperature is approximately 1200° C. As the laser ablates the target, carbon nanotubes form and are carried by the gas flow onto a cool copper collector. Like carbon nanotubes formed using the electric-arc discharge technique, carbon nanotube fibers are deposited in a haphazard and tangled fashion.

Unfortunately, although these methods can produce large quantities of nano tubes, their cost still precludes any large-scale applications. Further, these naturally occurring varieties, because of the highly uncontrolled environment in which the carbon nano tubes are produced, are highly irregular in size and quality, lacking the high degree of uniformity necessary to meet the needs of both research and industry. It is necessary to produce these nano tubes at low cost and with the required purity and physical properties (controlled length and chirality) for applications in a high volume industrial process.

Recently, U.S. Pat. Nos. 7,052,667; 7,033,647; 6,986,877; 6,974,627; 6,967,043; 6,844,061; 6,780,075; 6,759,024; 6,730,398; 6,413,487; and 5,773,834 all disclose various processes of making carbon nano tubes. When making carbon nano tubes in the gas phase, the length cannot be controlled. In the process of making carbon nano tubes using plasma or sophisticated energy sources such as e-beam, laser beam, the product cost increases even thought this process can produce fine carbon fibers and several different kinds of carbon nano tubes. U.S. Pat. No. 6,743,500 discloses a production method by producing a combination of (1) a polymer material that disappears upon thermal decomposition, and (2) carbon precursor polymers. The polymer material is thermally decomposed. Carbon is formed from the carbon precursor polymers. The foregoing combination includes micro-capsules that include a shell of the carbon precursor polymers on the polymer material that disappears upon thermal decomposition. The thermal decomposing and the forming are performed by baking the micro-capsules. The micro-capsules are prepared by an interfacial chemical technique. The micro encapsulation technique is normally complicated and expensive for large volume production as the raw material preparation needs more complicated steps.

It would be an advantage to synthesize carbon nano tubes and fibers in high volume at low cost by using inexpensive equipment.

### SUMMARY

In one implementation, technologies are disclosed for combusting and heating low cost, easily handled solid phase raw materials to synthesize carbon nano fiber and tubes to as to result in high yield, in a large scale production, and at low cost. The carbon nano fiber and tubes can be synthesized without using laser sources, arc discharge electrodes, or plasma sources. The carbon nano fibers thus synthesized can be used as filaments in light bulb applications as well as for other light emitting devices such as large dimension display devices. The carbon nano fiber and tubes thus synthesized can show strong magnetization properties. The nano carbon materials thus synthesized can also show high electrical conductivity so as to be useful as an electro catalyst, an electrode, and as a fuel diffusion layer for a fuel cell proton exchange membrane.

### BRIEF DESCRIPTION OF THE DRAWINGS

A more complete understanding of the implementations may be had by reference to the following detailed description when taken in conjunction with the accompanying drawings wherein:

FIG. 1 shows a general schematic of a reactor using a gas stove for a solid phase synthesis of carbon nano tubes and carbon nano fibers;

FIG. 2 shows a general schematic of a reactor using an electric stove for a solid phase synthesis of carbon nano tubes and carbon nano fibers;

FIG. 3 shows a raw material container for the reactor seen in FIG. 1;

FIG. 4 shows an FE-SEM micrograph of a carbon nano fiber product synthesized in a solid phase without using a tube control agent;

FIG. 5 shows an FE-SEM micrograph of a carbon nano tube product synthesized in a solid phase using a tube control agent;

FIG. 6 shows a TEM micrograph of a carbon nano tube product using a tube control agent as applicable to Example 2 herein;

FIG. 7 shows an XRD graph of a carbon nano tube product synthesized in a solid phase using a tube control agent;

FIG. 8 shows an XRD graph of a carbon nano fiber product synthesized in a solid phase without using a tube control agent;

FIG. 9 shows an FE-SEM micrograph of the carbon nano tube product synthesized in a solid phase using CaC2 as a carbon source and a tube control agent from pine wood and pine wood resin;

FIG. 10 shows an XRD graph of a carbon nano tube product synthesized in a solid phase using a tube control agent;

FIG. 11 shows an Ft-IR chart of a carbon source used to synthesize nano carbon materials in a solid phase;

FIGS. 12-16 show respective schematic structures of an GaN LED with and without a carbon nano tube and/or fiber interlayer as synthesized in a solid phase by techniques disclosed herein; and

FIG. 17 is a graph of light output power versus current for examples and comparisons presented herein.

### DETAILED DESCRIPTION

Implementations synthesize solid phase synthesized carbon nano tubes and carbon nano fiber characterized by X-Ray diffraction peaks appearing at two theta angle=26.5°, 42.5°, 44°; at two theta=26.5°, 44.5°, 51.8°; and at two theta=44.5°, 51.8°. These solid phase synthesized carbon nano tubes and carbon nano fibers can be produced by a combined process of combustion and heating of solid raw materials in an oxygen free environment. The combustion and heating process, which can be performed in a brick manufacturing furnace, will preferably be a multi-phase and multi-component process that uses at least one solid component that is a carbon source, a tube control agent, a combustible agent, and a metal related catalyst. These functions can exist on separated molecules or can co-exist in one or more than one molecules.

The carbon source in the solid phase raw materials can be non-polymeric and polymeric materials having at least one of the following bondings: a triple bond, a double bond, or a single bond which links two adjacent carbon atoms such as CR₁≡CR₂, —CR₁═CR₂—, and —CRiR₂—CR₃R₄— in which R₁, R₂, R₃, R₄ can be metal, H, alkyl, aryl, alkenes, alkenyl, —SH, —OH, —COOH, —CO—, —CHO, —COOR, —SO₃H, —O—, —S—, —NO₂, —NH₂, —CN, —SO₂—, —SO₂Cl₂, -acid salts (carbonium, iodonium, phosphonium, pyrylium, ammonium, . . . etc), —NR₁R₂ (R₁, R₂=hydrogen, alkyl, aryl, etc.), or a halogen (Cl, I, F, or Br).

The carbon source will preferably be a flammable solid including but not limited to pine wood, pine wood resin, eucalyptus leaves, eucalyptus oils, calcium carbide, silicone carbide, jatropha curcas seed, jatropha curcas seed oil, cellulosic materials including but not limited to cloths, cotton, paper and the like, vegetable oil, sun flower oil, pumpkin seed oil, lindseed oil and the like, rubber tree resin, rubber waste, palm wicker, paddy shell, straw, organometallic compounds including but not limited to acetyl acetonates of Ni, Co, Cu, Fe and the like, diesel oil, kerosene oil, and solid fatty acids from birds, mammals, fish, etc. The solid carbon source can be used alone or blended with other liquid carbon sources. The carbon source will preferably have molecules that will show an Ft-IR spectroscopic chart with maximum peaks at wave number of 1065 and 1047 cm⁻¹.

The tube control agent will preferably have a hydroxyl functional group —OH, a thionyl functional group, a carbonyl functional group —CO (including but not limited to pure CO, ester-COO—, carboxylic acid —COOH), an ether functional group —O—, alkoxides, hydrides and the like, or a combination of at least more than one component among the above cited compounds. Tube forming enhancer molecules may carry other conventional functional groups besides the above cited functionalities including but not limited to H, alkyl, aryl, alkenes, alkenyl, —SH, —OH, —COOH, —CO—, —CHO, —COOR, —SO₃H, —O—, —S—, —NO₂, —NH₂, —CN, —SO₂—, —SO₂Cl₂, -acid salts (carbonium, iodonium, phosphonium, pyrylium, ammonium, etc,), —NR₁R₂ (where R₁, R₂ are hydrogen, alkyl, aryl, etc.), or halogen (Cl, I, F, or Br).

The combustible agent will preferably be exhibit ignition, flame ability, and combustion. The metal related catalyst(s) can be organometallic compounds, metal chelates, salts, acids, ester, or oxides of metals and lanthanide, actinide elements described in the periodic chart including but not limited to Cr, Mn, Mg, Fe, Zn, Co, Ni, Pt, Pd, Ag, Au, Cu, Al, Si, Ti, V, Nb, Mo, Hf, Ta, or W.

The specific solid raw material used to synthesize carbon nano fibers and tubes can be prepared by a solvent evaporation process using an oven, a vacuum from a mask, a bulk, or a thin and/or a thick film product from any known solvent coating process including but not limited to spin coating, dip coating, bar coating, spray coating, hopper coating, doctor blade coating, etc. on a high heat resistant substrate including but not limited to semiconductors, oxides, metals, ceramics, or polymer carbon related materials.

The specific solid raw material used to synthesize carbon nano fibers and tubes can be prepared by a physical vapor deposition (PVD) process or a chemical vapor deposition process (CVD) on high heat resistant substrates including but not limited to semiconductor, oxides, metals, ceramics, or polymer carbon related materials.

The oxygen free environment can be prepared by use of a vacuum source or by inserting into the reaction chamber inert or non-oxidizing gases including but not limited to Ar, He, N₂, H₂, hydrocarbon gases, NH₃ and the like. The reaction chamber will preferably be made out of heat resistant systems which can be heated by gas burning, electric heater, or by wood burning. The reaction chamber will preferably be provided with holes or other gas outlets to evacuate outgassed species from the raw materials.

The process of synthesizing carbon nano tubes and fibers will preferably control the length of thereof. The carbon nano tubes and carbon nano fibers can be used to fabricate low cost Light Emitting Diodes (LEDs), low cost filaments for light bulb applications, electro catalysts, electrodes, for a fuel penetration layer for a fuel cell, for a heat dissipation layer and/or heat management layer for a semiconductor laser, a laser diode (LD), a light emitting diode (LED), or a nano transistor device.

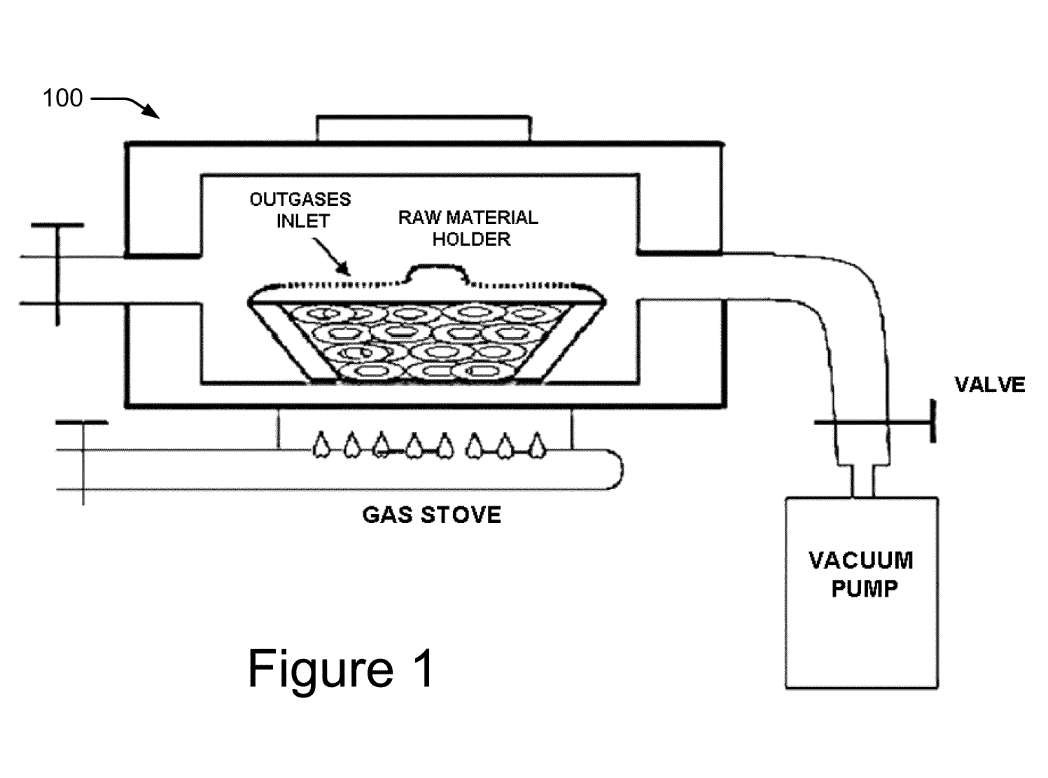

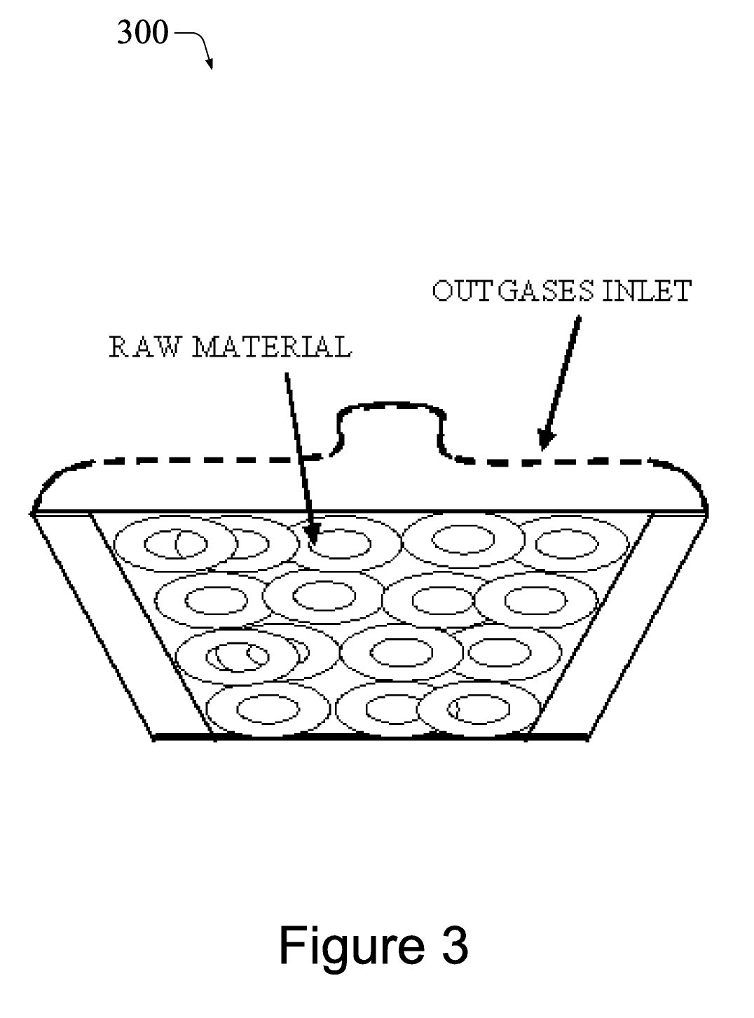

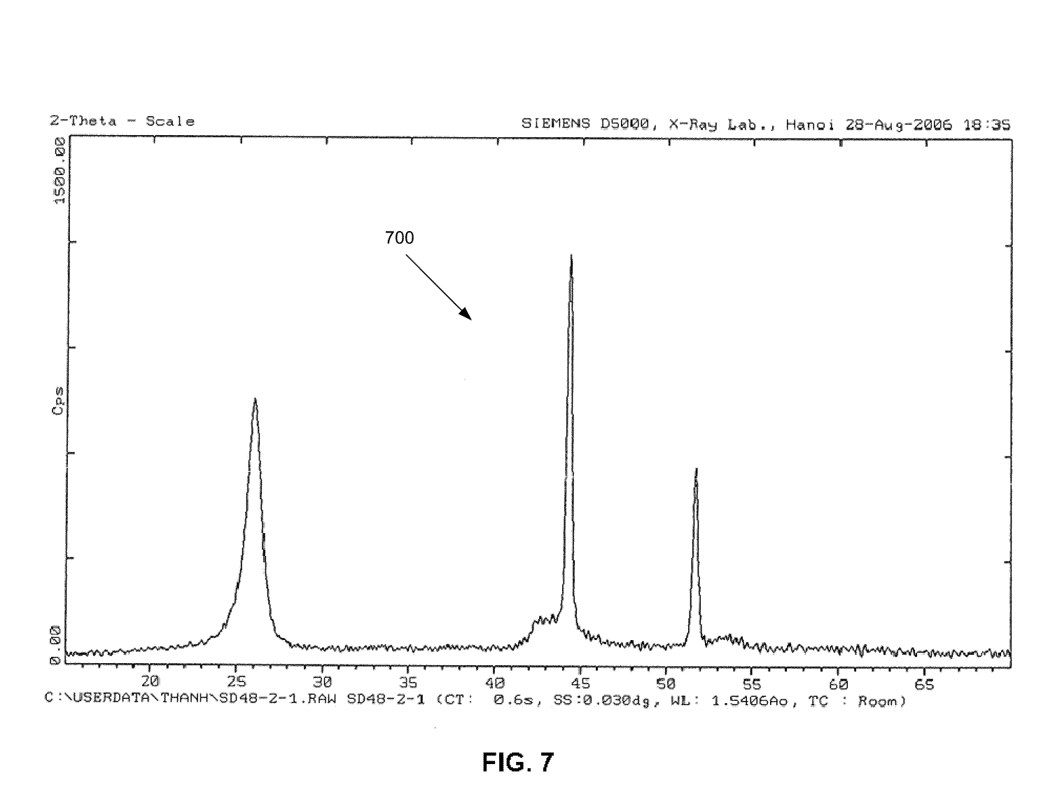

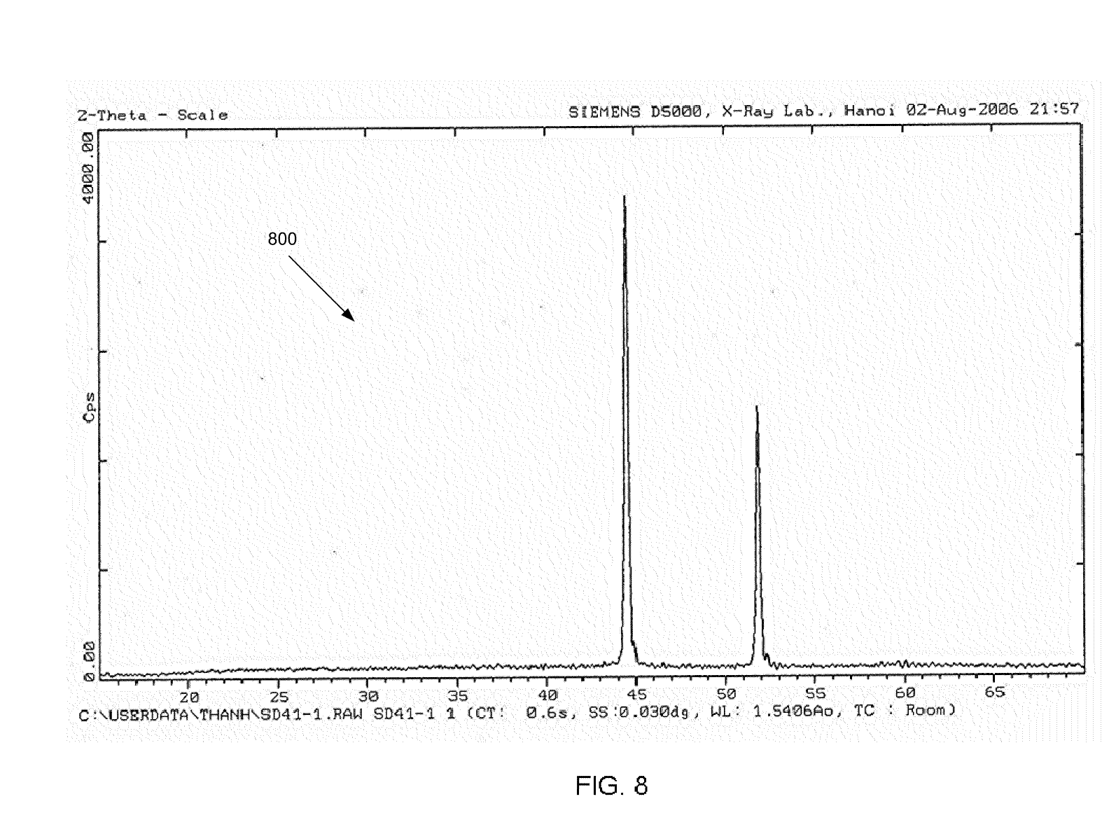

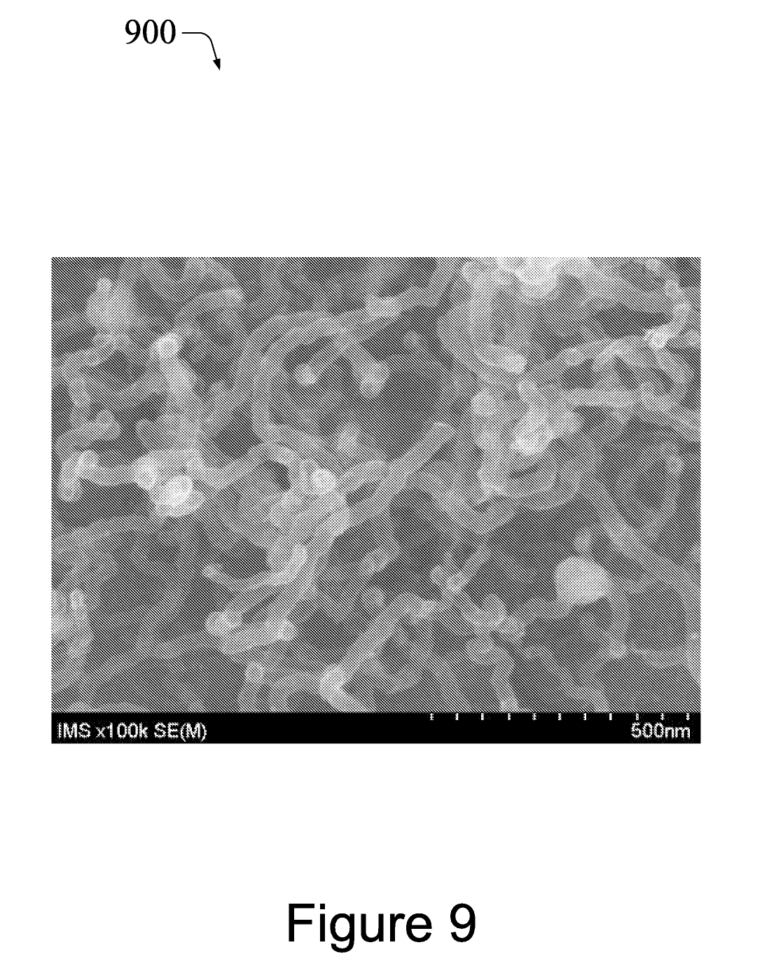

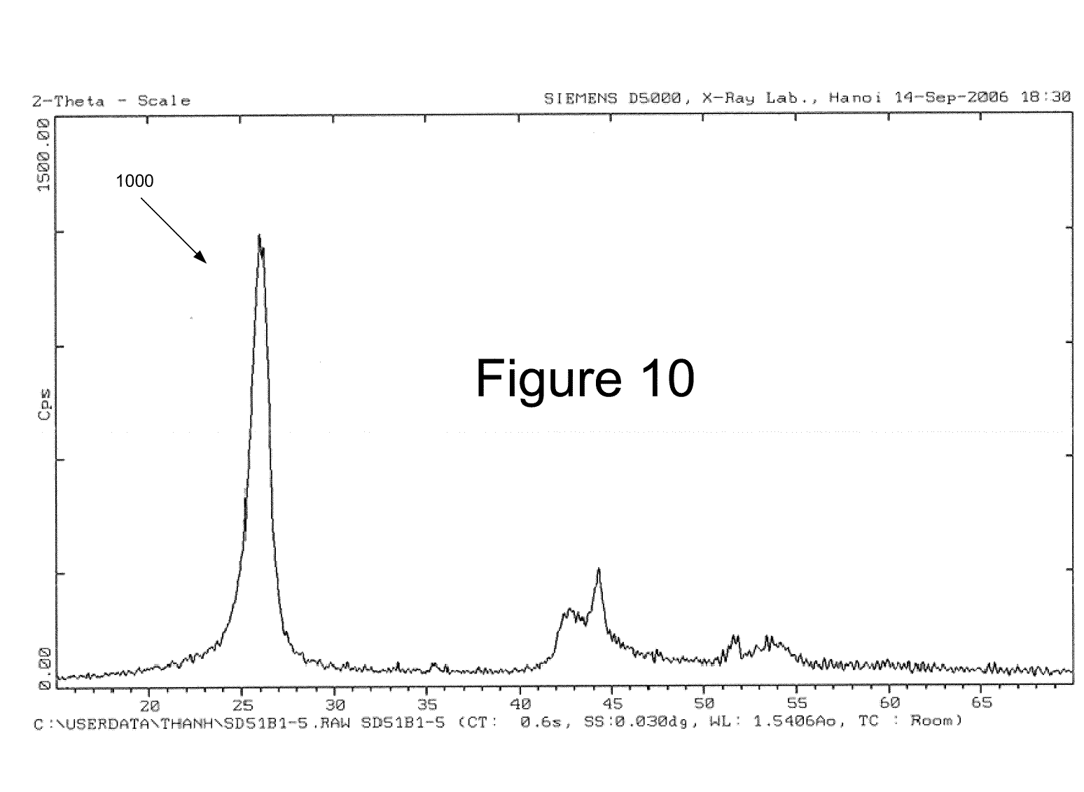

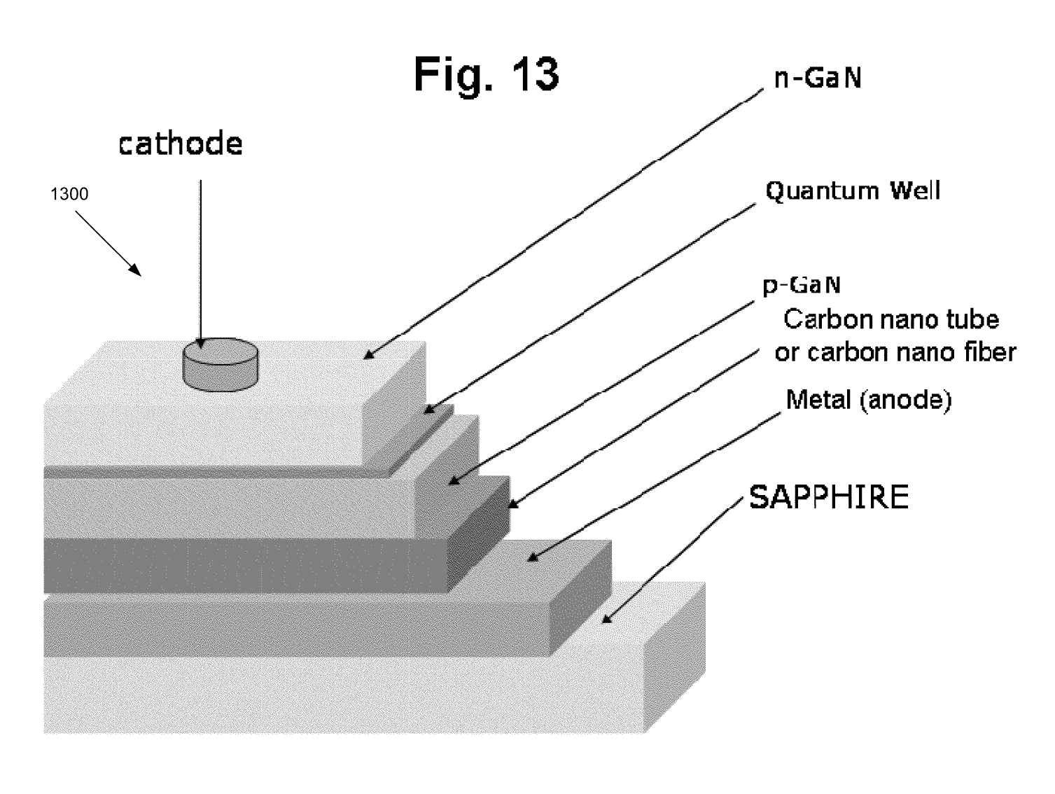

The foregoing implementations will now be further described by reference to FIGS. 1-17.

### A. Combined Combustion and Heating

A combustion process, which doesn't need expensive equipments such as plasma CVD or thermal CVD, can be done in a manufacturing furnace made of high heat resistant materials to produce carbon nano tubes and fibers on a large scale as compared to the arc discharge process, the laser ablation process and other sophisticated plasma CVD processes. The solid raw material will preferably be burned or combusted and then heated to give rise to carbon nano tubes and related products such as carbon nano fibers. The reaction chamber carrying out this process is a closed box containing substantially no oxidizing gases, such as oxygen, and will preferably be made out of high heat resistant materials such as ceramics, bricks, stone, Pyrex glass, stainless steel systems, etc., which can be heated by burning gas or wood, or by an electric heater. The thermal energy inside the closed box is accumulated to reach the needed temperature that will generate the flame, and then followed with a heating process which causes the formation of carbon nano tubes. The closed box can equipped a vacuum pump or similar mechanism, as seen in FIG. 1 at reference numeral 100, to remove the inside air or to supply suitable gases to create therein a non-oxidizing environment.

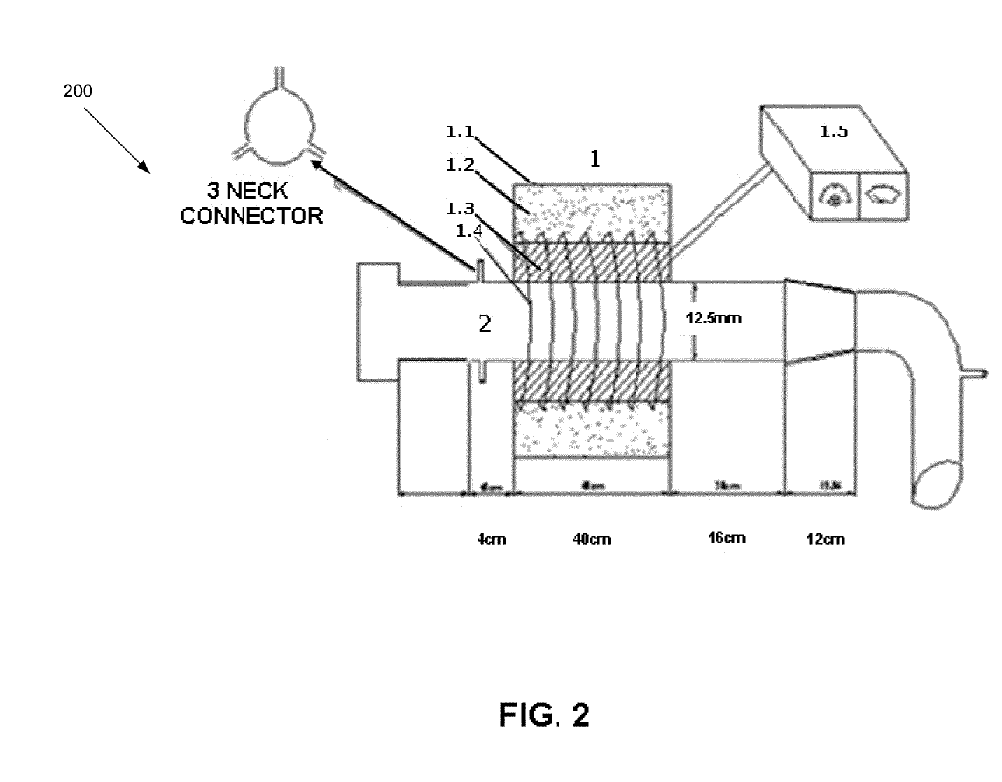

In one implementation, the solid phase synthesis of carbon nano tubes can be performed by several steps. To begin, pre-made solid raw material is placed within a combustion and heating chamber having gas outlet to evacuate the out gassed species that are created when heat is applied to the combustion and heating chamber, examples of which are seen in FIGS. 1-2 respectively at reference numerals 100 and 200. During heating, an oxygen free environment within the combustion and heating chamber is formed by an evacuation that is associated with an air suction pump system to create a vacuum pressure in the range from about 10⁻² to about 10⁻³ Torricelli. Alternatively a non-oxidizing environment within the combustion and heating chamber can be formed by purging the inside of the combustion and heating chamber with inert gases or a mixture of inert gases (Ar, He, N₂, etc.) with other gases such as H₂ and/or hydro carbon gases, where this purging can occur partially or entirely at the reaction time.

The combustion and heating chamber can be heated to a predetermined temperature such as by using a heat controller that is equipped with thermo-couple. A timer can be used to heat the combustion and heating chamber until the end of the process at which time the positive heating the combustion and heating chamber is stopped. The oxygen free environment is maintained until the temperature of the combustion and heating chamber drops to room temperature. Gases within the combustion and heating chamber are removed and the product of the process is removed from the combustion and heating chamber.

Upon the optimization of the parameters of the process, such as of the ratio of a tube forming enhancer, a carbon source, and a metal catalyst, as well as the heating temperature and time of the combustion and heating chamber, the reaction yield can reach up to ninety percent (90%) with substantial uniformity of the resultant carbon nano tube product in the scale of 10-100 kg/batch. The above described process starts combustion and heating slowly from room temperature. In another implementation, the raw materials can be inserted into the combustion and heating chamber when it is already pre-heated to a predetermined temperature.

### B. The Raw Materials

The solid raw materials utilized will preferably be a combination containing at least one solid component of a carbon source, a tube control agent, a combustible agent, and a metal related catalyst. These components can exist on separated molecules or can co-exist in one or more than one molecules.

1. The Carbon Source.

The carbon source contained in the solid phase raw materials will preferably be a flammable substance that includes non-polymeric and polymeric materials having at least one of the following bondings: a triple bond, a double bond, a single bond which links two carbon atoms such as CR₁≡CR₂, —CR₁═CR₂—, or —CR₁R₂—CR₃R₄— in which R₁, R₂, R₃, R₄=metal, H, alkyl, aryl, alkenes, alkenyl, —SH, —OH, —COOH, —CO—, —CHO, —COOR, —SO₃H, —O—, —S—, —NO₂, —NH₂, —CN, —SO₂—, —SO₂Cl₂, -acid salts (carbonium, iodonium, phosphonium, pyrylium, ammonium, etc.), —NR₁R₂ (R₁, R₂=hydrogen, alkyl, aryl.), or -halogen (Cl, I, F, Br). These chemicals can also be found in natural and in man made sources such as unsaturated aliphatic compounds, unsaturated aromatic compounds, an unsaturated monomer and its derivatives, unsaturated oils and their derivatives, unsaturated fatty acids and their derivatives, unsaturated polymers and copolymers and their derivatives, organ metallic compounds having unsaturated bonds and its mixture with more than one components. These chemicals can also have saturated bonds including but not limited to saturated aliphatic compounds, saturated oils and their derivatives, saturated fatty acids and their derivatives, saturated polymers and copolymers and their derivatives, and organ metallic compounds having saturated bonds. The examples of solid carbon sources for solid phase synthesis of carbon nano tubes include but are not limited to calcium carbide, silicone carbide, pine wood, eucalyptus leaves, jatropha curcas seed, jatropha curcas seed oil, rubber tree wood, rubber tree resin, rubber waste, pine wood resin, dimethyl acetylenedicarboxylate (Aldrich Cat D13,840-1), dimethyl acetylscuccinate (Aldrich Cat 28,020-8), dimethyl adipate (Aldrich Cat 18,625-2), palmitic acid, palm wicker, paddy shell, straw, organ metallic compounds including but not limited to acetyl acetonates of Ni, Co, Cu, Fe, and the like, diesel oil, kerosene oil, solid fatty acids from birds, mammal animals, fishes, etc. These solid carbon sources can be blended with other liquid carbon sources including but not limited to cocobetaine, eucalyptus oil, coconut oil, peanut oil, vegetable oil, sun flower oil, pumpkin seed oil, linseed oil and the like. The content of carbon sources in the solid raw material for the solid state synthesis process of carbon nano tubes and carbon nano fibers is in a range from about 0.01% wt to about 100% wt, preferably, in a range from about 5% wt to about 80% wt, more preferably in a range from about 20% wt to about 70% wt.

2. The Tube Control Agent.

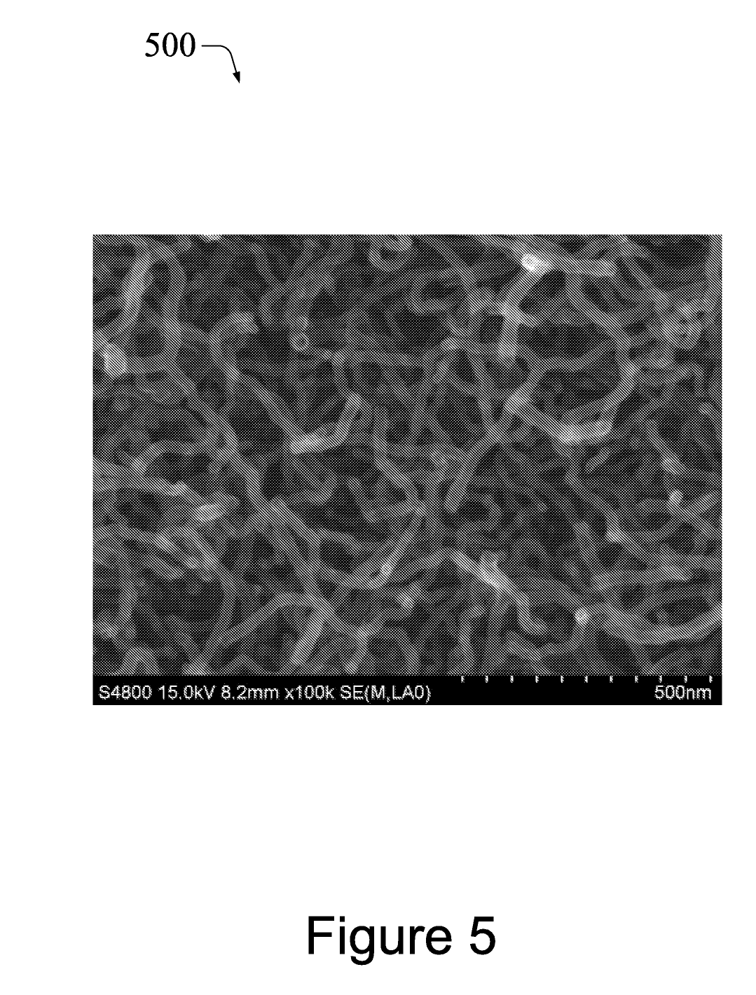

The tube control agent is different from metal catalysts and can generate tubes from carbon during the combustion and heating process of the solid phase raw material. Without the tube control agent, the burned products will show a wicker shape of carbon nano fibers or carbon nano wire as shown in FIG. 5 at reference numeral 500. The tube control agent can be contain hydroxyl functional groups —OH, carbonyl functional groups —CO (such as but not limited to pure CO, ester-COO—, carboxylic acid —COOH), ether functional groups —O—, alkoxides, and hydrides and the like selected from inorganic and organic compounds with and without chemical functional groups including but not limited to carbonyl —CO, carboxylic —COOH, sulfonic acid —SO₃H, -acid salts (carbonium, iodonium, phosphonium, pyrylium, ammonium, . . . etc), aldehydes —CHO, hydroxyl —OH, -thionyl SH, -amino —NR₁R₂ (where R₁, R₂=hydrogen, alkyl, aryl, etc.), —SH, —NO₂, —CN, and -halogen (Cl, I, F, Br). The examples of a tube control agent containing specific inorganic hydroxide compounds include but are not limited to KOH, NaOH, Ca(OH)₂, Ni(OH)₂, Co(OH)₂, Fe(OH)₂, Fe(OH)₃, Mn(OH)₂, Mg(OH)₂, Zn(OH)₂, Sn(OH)₄, Cu(OH)₂, LiOH , etc. The examples of a tube control agent containing organic compounds include but are not limited to cellulose materials including wood, pine wood, straw, paddy shell, coconut shell, palm wicker, paper, cloth, cotton, etc. and the like, hydroxylated polymer including but not limited to polyvinyl alcohol, poly vinyl butyral, ethylene glycol, polyethylene glycol, sugar, polyethylene oxides, poly vinyl pyrrolidone, hydroxylated polyester, hydroxylated poly styrene, phenolic resin, phenol formaldehyde polymer, high boiling point alcohols including but not limited to 1,7-Heptanediol(Aldrich Cat H220-1), 1,5-pentanediol (Aldrich Cat 26,028-2), 1,6-Dibromo-2-napthol(Aldrich Cat D4,180-5), 1,2,3-Heptanetriol (Aldrich Cat 28,423-8), and organic alkoxides compounds including but not limited to LiOC2H5, NaOCH3, hydride compounds including but not limited to LiH, NaBH4, etc. The content of a tube control agent in the solid raw material for the solid state synthesis process of carbon nano tubes and carbon nano fibers is in a range from about 0.01% wt to about 100% wt, preferably in a range from about 1% wt to about 80% wt, and more preferably in a range from about 10% wt to about 50% wt.

3. The Combustible Agent.

A combustible agent is needed to form a flame in a first stage of combustion. When the temperature reaches a flash point, the combustible agent ignites and generates a flame for the entire process of synthesizing carbon nano tubes. It is believed that tubes are formed when the process shows begins to show the flame at the beginning of the combustion. Example of the combustible agent contained in the solid raw materials include but are not limited to wood, wood dust, pine woods, pine wood dust, eucalyptus leaves, coal, tar, charcoal, mud coal, diesel oils, kerosene oils, cellulose materials including but not limited to cloth, cotton, paddy, straw, and alcoholic fuels in solid form. Natural sources include pine wood resin, eucalyptus oil, peanut oil, palm tree oil, and rubber tree resin. The content of the combustible agent in the solid raw material for the solid state synthesis process of carbon nano tubes and carbon nano fibers is in a range from about 0.01% wt to about 100% wt, preferably in a range from about 1% wt to about 30% wt, more preferably in a range from about 5% wt to about 20% wt.

Given the foregoing, and with carbon nano tube engineering optimizing the raw material components, he tube forming agent, the combustible agent and the carbon source in the solid phase materials sometimes can exist in one material.

4. Metal Related Catalyst.

A catalytic substance can be used as a component of the solid raw materials used for a solid phase synthesis process for carbon nano tubes and fibers. Such a catalyst can be organometallic compounds, metal chelates, salts, acids, ester, and hydroxides of metal or metal alloy related elements including the class of lanthanide and actinide elements as described in the periodic chart. Examples of a metal related catalyst include acetyl acetonates of Cu, Ni, Fe, Co, Mg, Mn, and the like, metal heptanedionates such as copper bis 92,2,6,6-tetramethyl-3,5-heptanedionate (from Aldrich cat 34,508-3), and Platinum0)-2,4,6,8-tetramethyl-2,4,6,8-tetravinylcyclotetrasiloxane complex (Aldrich 47,954-3). The content of the metal catalyst in the solid raw material for the solid state synthesis process of carbon nano tubes and carbon nano fibers is in a range from about 0.01% wt to about 70% wt, preferably in a range from about 1% wt to about 40% wt, and more preferably in a range from about 3% wt to about 10% wt.

5. Carbon Nano Tube Length Controlling Capability

Non-uniformity in carbon nano tube length is a concern in the gas phase process of making carbon nano tubes, especially in the case of single walled carbon nano tubes. To address this concern, the solid raw materials can be formed into a uniform thin film by various processes including but not limited to spin coating, dip coating, bar coating, spray coating, hopper coating, doctor blade coating, etc. The uniform thin film will preferably be formed on a high heat resistant substrate including but not limited to semiconductors, oxides, metals, ceramics, polymer carbon related materials. The carbon nano tubes can be grown on the high heat resistant substrate through the combustion and heating process above described. The thickness of the solid raw material will control the length of the carbon nano tubes, dependant upon the selection of the raw materials. Due to the solid components of the raw materials, the uniform solid film can be achieved with a solvent evaporation process after the process of solvent coating as above described. Thus, the uniformity of the thickness of solid raw material can be used to control the length of the carbon nano tubes when the high heat resistant substrate contains a thin layer of a metallic catalyst—either with or without the presence of a tube forming agent. The catalyst layer can be prepared by any known arts including PVD, CVD, a sol-gel process, and a solvent coating process.

After the catalyst layer is made, the solid raw material layer can be deposited or coated over the top of the catalyst layer. The tube forming agent can exist in both the catalyst layer as well as in the raw material layer, or in only one of these two (2) layers. As such, the disclosed techniques for using solid raw materials in a solid phase carbon nano tube synthesis process can help to form a uniform, thin film of carbon nano tubes and carbon nano fibers. These carbon nano fibers are useful as low cost filaments in light bulb applications as well as for other light emitting devices such as a large dimension display device.

The carbon nano tube and carbon nano fiber products of the solid phase synthesis process implementations disclosed herein provide nano carbon products showing strong magnetization properties. These nano carbon materials also show high electrical conductivity which can be used as an electro catalyst, an electrode, and as a fuel diffusion layer for a fuel cell proton exchange membrane.

### C. EXAMPLES

### 1. Example 1

### Preparation of the Solid Raw Material

One (1) g of FeCl₃ was completely dissolved in a mixture of a solvent containing ten (10) g of DI water and five (5) g of methanol. Then six (6) g of palm dust and three (3) g of pine wood resin were added into the solution and stirred at room temperature for thirty (30) minutes, then heated up to one hundred degree Celsius (100° C.) for a further ninety (90) minutes to achieve a light brown solid powder.

### 2. Example 2

### Synthesis of Carbon Nano Tubes in a Solid Phase

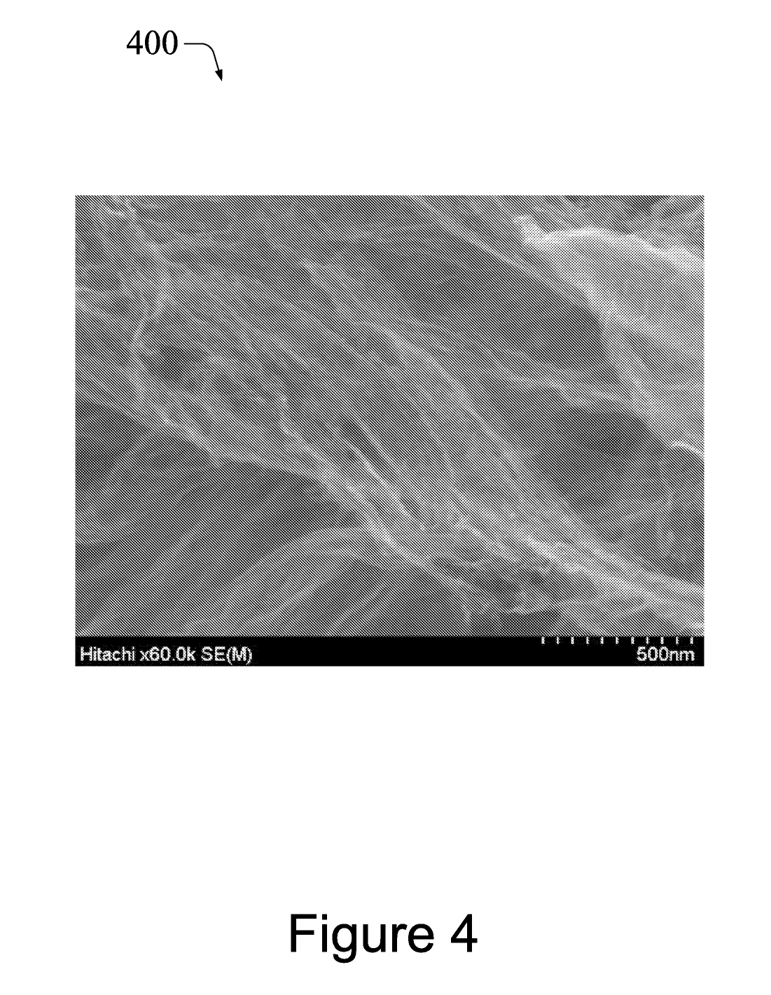

The solid raw materials described in the Example 1 were weighed into a quartz tube and then inserted into the reaction chamber, as shown in FIG. 2 at reference numeral 200, which is pre-heated to nine hundred degree Celsius (900° C.) and filled with N₂ gas at the flow rate of 2.5 liters/minute. Then, the flame inside the reaction chamber was started and the heating was continued for two (2) hours. Afterward, the positive heating was stopped and a flow of N₂ gas was continued until the temperature of the chamber dropped to room temperature. The quartz tube was removed and the black product inside the quartz tube was collected. The black product showed a significant increase of magnetic properties, and was tested. The results of the tests are shown by the FE-SEM, TEM, and XRD images seen at reference numerals 400-1000 respectively in FIGS. 4-10.

### 3. Comparison of Examples 1 and 2

Examples 1 and 2 were repeated except that palm dust was not included. The resultant FE-SEM micrograph is seen at reference numeral 400 in FIG. 4, from which it is seen that the carbon nano tubes were not synthesized. Rather, fine strings of carbon nano fibers were synthesized. From this it can be concluded that cellulose material, a representative of which is palm dust, is effective as a tube forming agent.

### 4. Example 3

Example 3 repeats Example 1 except that pine wood dust is used instead of palm dust.

### 5. Example 4

### Synthesis of Carbon Nano Tubes in a Solid Phase

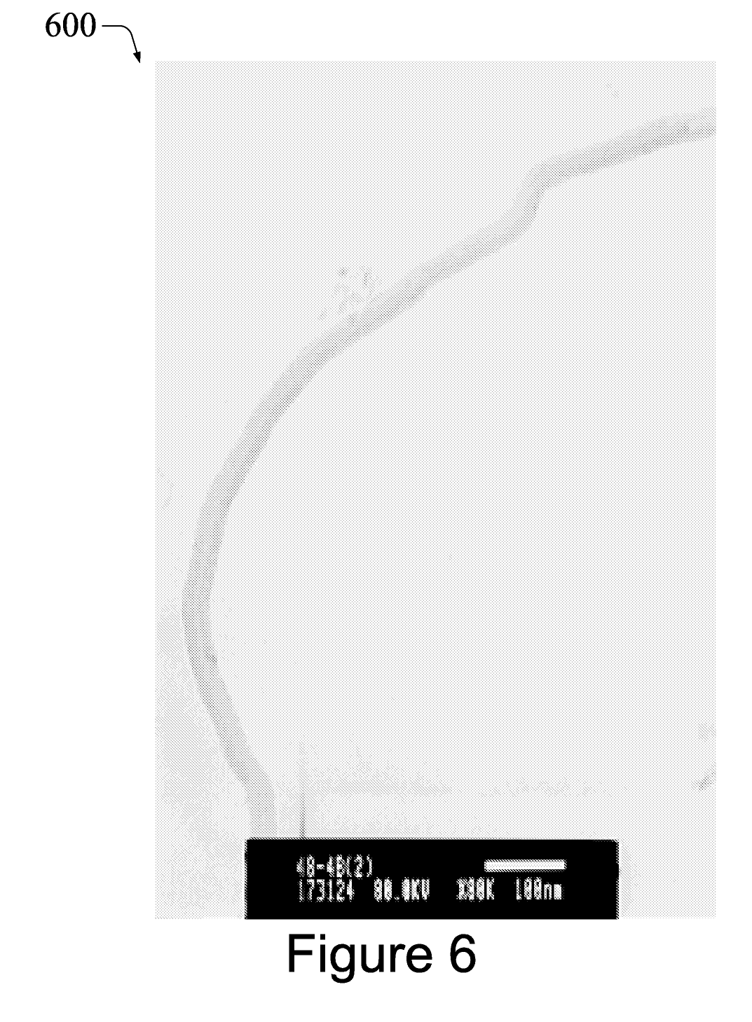

Seven (7) grams of solid raw materials as described in Example 3 were mixed with 10 g of calcium carbide by a dry grinder. Then, all of the solid powder was transferred into the quartz tube (see the pyrex glass annealing chamber 2 at reference numeral 200 in FIG. 2) and then inserted into the reaction chamber (see reference numeral 100 in FIG. 1) which was pre-heated to nine hundred degree Celsius (900° C.) and filled with N₂ gas at a flow rate of 2.5 liters/minute. Then, a flame inside the reaction chamber was started and the heating continues for two (2) hours. Afterward, the heating was stopped but the N₂ gas flow was continued until the chamber temperature dropped to room temperature. The quartz tube was removed and the black product inside the quartz tube was collected. The black product shows a significant increase in magnetic properties, and was tested. The result of the test is seen in the TEM image at reference numeral 600 shown in FIG. 6.

### 6. Example 5

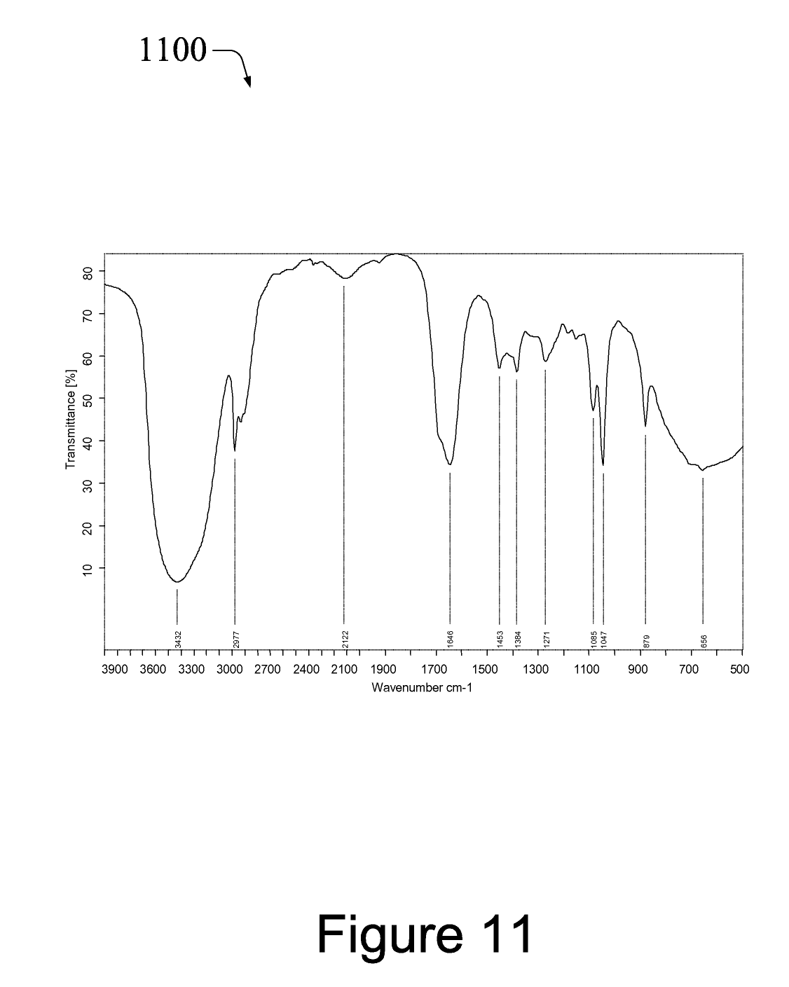

In Example 5, a carbon source was used successfully in the synthesis of carbon nano tubes tests of which resulted in the Ft-IR measurement graph as illustrated at reference numeral 1100 in FIG. 11.

### 7. Comparison Example 2

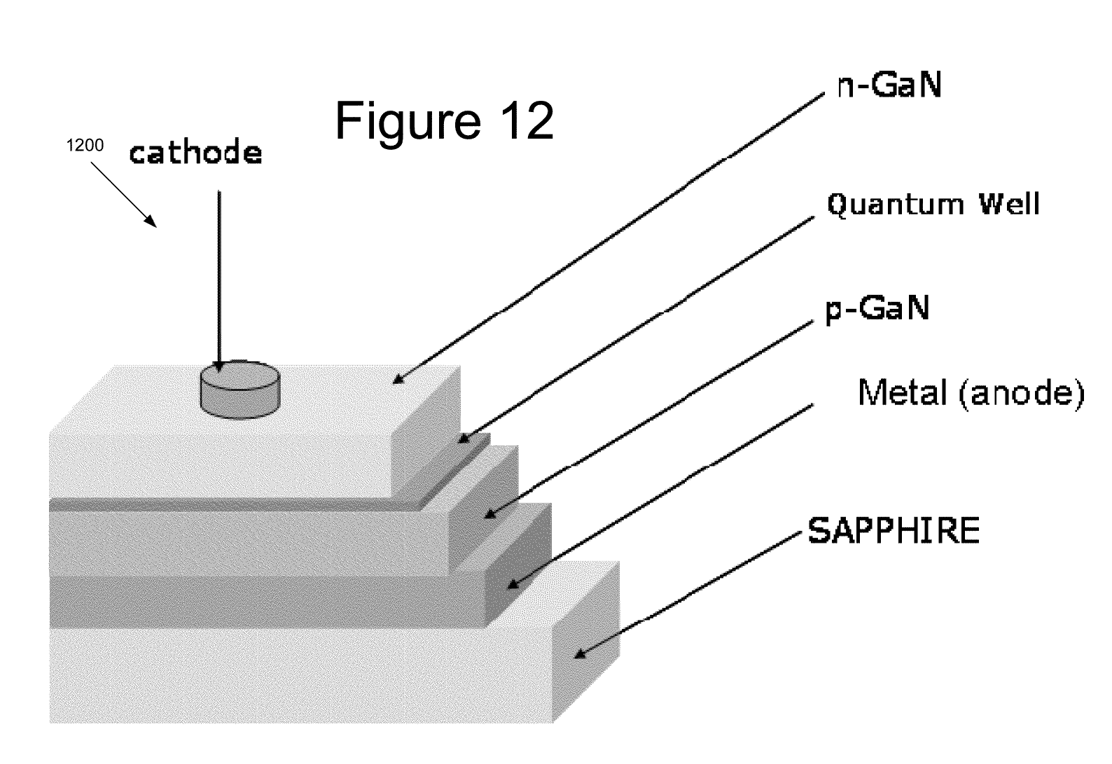

A sapphire wafer (2″ diameter) was inserted in a vacuum chamber of MOCVD (Metal Organic Chemical Vapor Deposition) equipment made of Aixtrom, Model AIX 2600G3 where a multi layer structure of a known device of blue Light Emitting Diode (LED) was built. This structure is composed of layers that include n-GaN/multi-quantum well (MWQ)/p-GaN sandwiched between two electrode metal layers as illustrated at reference numeral 1200 in FIG. 12.

### 8. Example 6

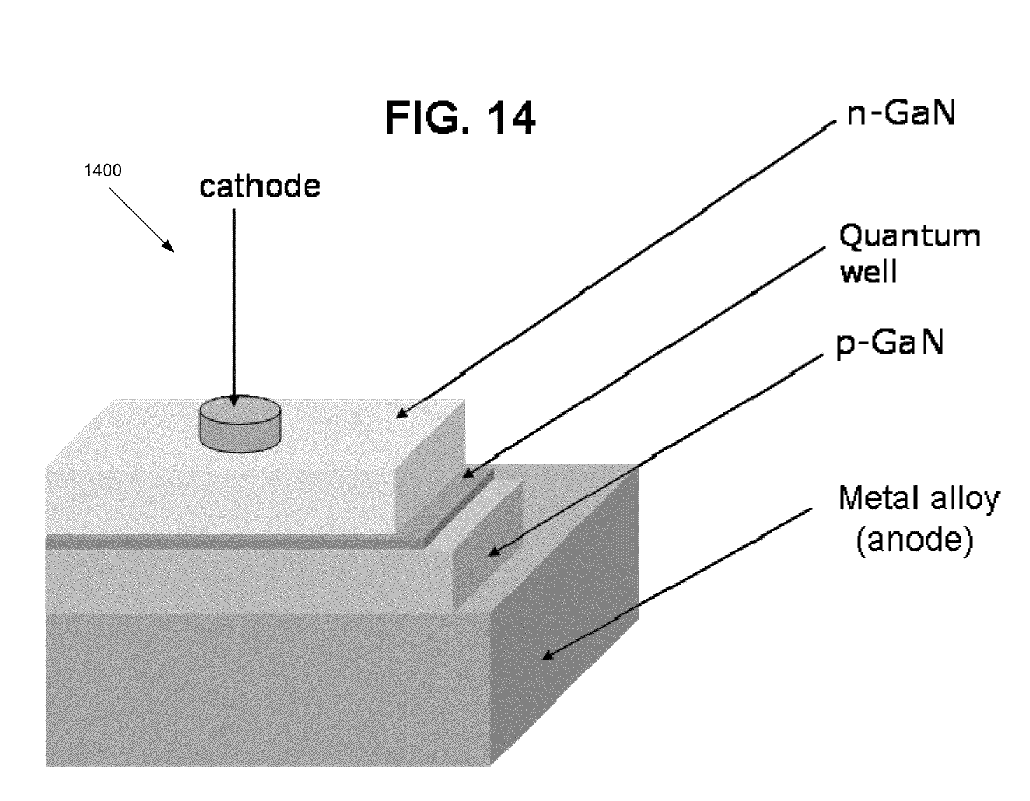

Example 6 is a repeat comparison of Example 2 except that on the top of the metal anode layer surface there is a carbon nano tube layer that is built by the process described in Example 1. The device structure is illustrated at reference numeral 1400 in FIG. 14.

### Comparison Example 3

Comparison Example 3 is a repeat comparison of Example 2 except that the sapphire substrate is replaced by a thick metal substrate, for example copper, and the device structure is illustrated at reference numeral 1400 in FIG. 14.

### Example 7

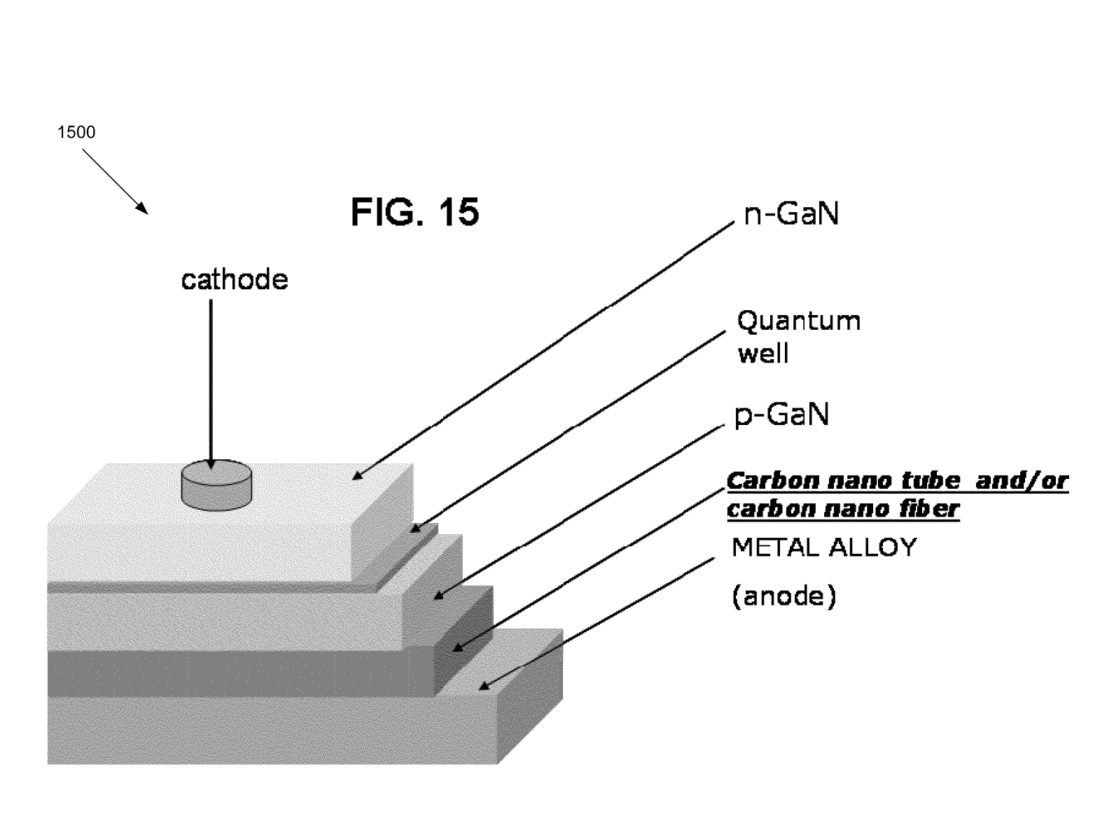

Example 7 is a repeat comparison of Example 3 except that on the top of the metal substrate (anode) a surface of a carbon nano tube layer was built by the process described in Example 1. The device structure is illustrated at reference numeral 1500 in FIG. 15.

### Example 8

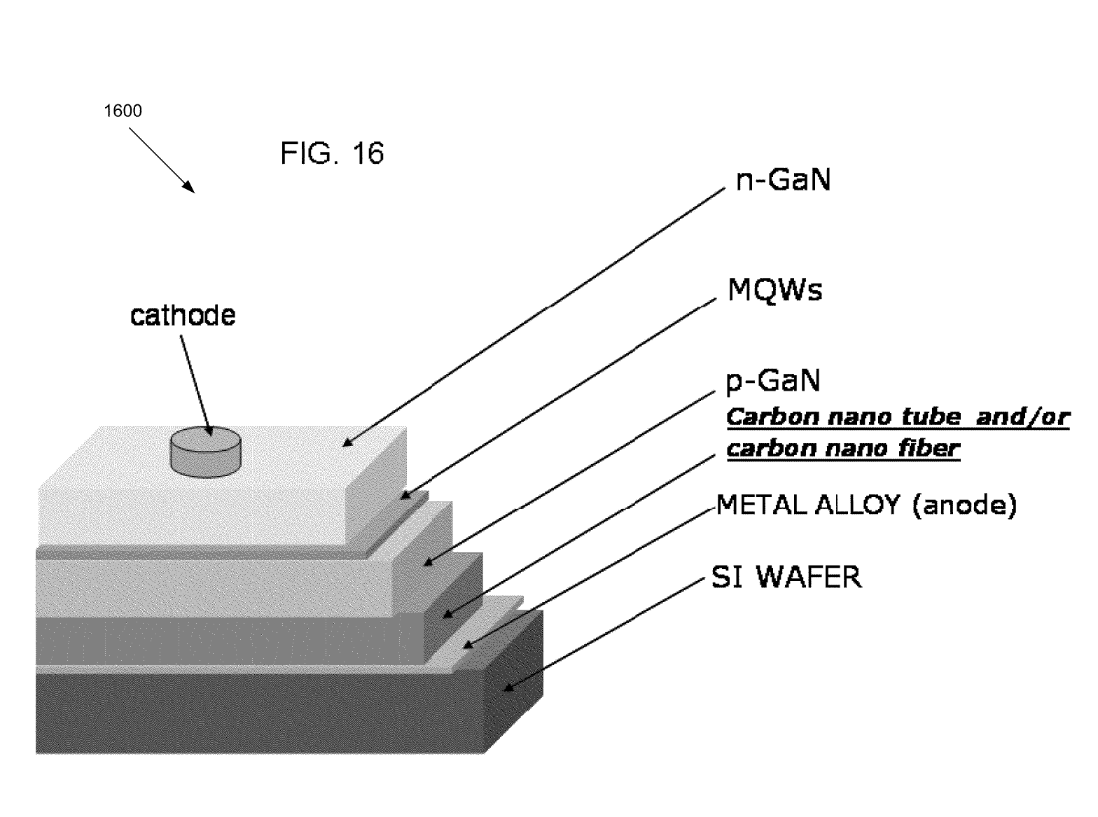

Example 8 is repeat of Example 6, except that a Si substrate was substituted for sapphire substrate. The device structure is illustrated at reference numeral 1600 in FIG. 16. On these devices seen at reference numerals 1200-1600 respectively in FIGS. 12-16, a bias of 3.1 V was applied and the emitted light output was measured as a function of current in mA. It is clear that the sapphire substrate showing the lowest thermal conductivity also shows this smallest light output power as is normally known. In this case, however, the interlayer of carbon nano tubes and/or carbon nano fibers was prepared by use of the following process:
The process was performed to form solid phase synthesized carbon nano tubes and carbon nano fibers characterized by X-Ray diffraction peaks appearing at two theta (2θ) angle or Bragg angle=26.5°, 42.5°, 44°; two theta (2θ)=26.5°, 44.5°, 51.8°; and at two theta (2θ)=44.5°, 51.8°.

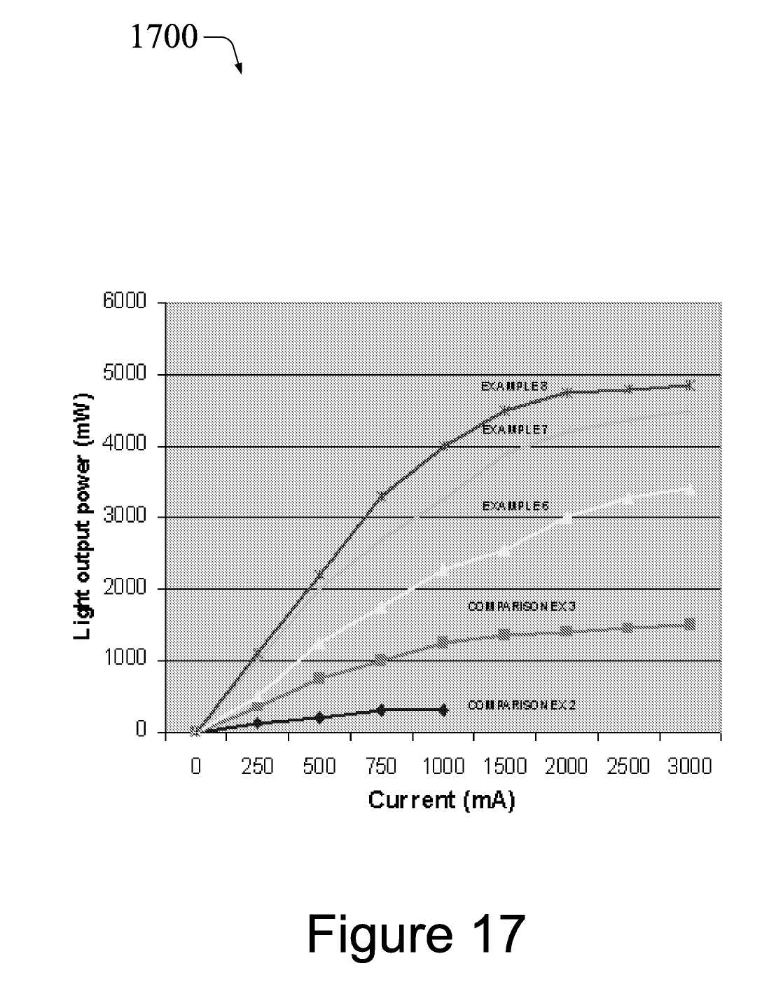

Examples 6-8 and comparison Examples 2-3, above, are charted in the graph seen at reference numeral 1700 of FIG. 17 which depicts, for each of these Examples, emitted light output as a function of current in mA.

While preferred embodiments of this invention have been shown and described, modifications thereof can be made by one skilled in the art without departing from the spirit or teaching of this invention. The embodiments described herein are exemplary only and are not limiting. Many variations and modifications of the method and any apparatus are possible and are within the scope of the invention. One of ordinary skill in the art will recognize that the process just described may easily have steps added, taken away, or modified without departing from the principles of the present invention. Accordingly, the scope of protection is not limited to the embodiments described herein, but is only limited by the claims that follow, the scope of which shall include all equivalents of the subject matter of the claims.

1. A composition of matter comprising a carbon nano material which, when exposed to an X-Ray, exhibits a set of X-Ray diffraction peaks appearing at different angles (Θ) selected from the group consisting of:
two theta (2Θ) angle=26.5°, 42.5°, and 44°;
2Θ=44.5°, and 51.8°;
2Θ=26.5°, 44.5°, and 51.8°; and
a combination of the foregoing, wherein the carbon nano material is formed by heating, in a substantially oxygen free environment, solid raw materials comprising:
a solid carbon source;
a solid tube control agent; and
a solid metallic catalyst.

2. (canceled)

3. The composition of matter as defined in claim 1, wherein the carbon nano material is formed into a component of an electrical device selected from the group consisting of a Light Emitting Diode (LED), an electro catalyst, an electrode, and a fuel cell fuel penetration layer.

4. The composition of matter as defined in claim 1, wherein the carbon nano material is formed into a heat dissipation layer.

5. The composition of matter as defined in claim 4, wherein the heat dissipation layer is a component in an electrical device is selected from the group consisting of a Light Emitting Diode (LED), a semiconductor laser, a laser diode, and a nano transistor device.

6. (canceled)

7. The composition of matter as defined in claim 1, wherein the carbon nano material is formed by a process selected from the group consisting of:
combustion; and
non-combustion heating of the solid raw materials in an oxygen free environment.

8. The composition of matter carbon nano material as defined in claim 7, wherein the oxygen free environment is:
formed within a reaction chamber; and
prepared by:
forming a vacuum within the reaction chamber; or
filling the reaction chamber with an inert or non-oxidizing gas selected from the group consisting of Ar, He, N₂, Hz, hydrocarbon gases, and NH₃.

9. The composition of matter as defined in claim 7, wherein:
the oxygen free environment is formed in a reaction chamber in which the process of non-combustion heating of the solid raw materials is performed by non-combustion heating a reaction chamber in a heating system selected from the group consisting of:
a gas burner,
an electric heater; and
the burning of wood.

10. The composition of matter as defined in claim 7, wherein the oxygen free environment is formed in a reaction chamber comprising a brick furnace.

11. The composition of matter carbon nano material as defined in claim 7, wherein the oxygen free environment is formed in a reaction chamber comprising a plurality of outlets to evacuate outgassed species from the solid raw materials during the non-combustion heating of the solid raw materials.

12. (canceled)

13. The composition of matter as defined in claim 7, wherein the solid raw materials are formed from by a process selected from the group consisting of:
a solvent evaporation process using an oven; and
a vacuum from a mask;
a bulk film, a thin film, or a thick film product formed by a solvent coating process including but not limited to spin coating, dip coating, bar coating, spray coating, hopper coating, doctor blade coating, and the like, wherein the coating is upon a high heat resistant substrate made of a material selected from the group consisting of semiconductors, oxides, metals, ceramics, and polymer carbon related materials.

14. (canceled)

15. The composition of matter as defined in claim 7, wherein the solid raw materials are combined with solid, liquid, and gas phase components.

16. The composition of matter as defined in claim 7, wherein the solid raw materials are composed of a single molecule with multifunctionality or are composed of more than one molecule with multifunctionality.

17. The composition of matter as defined in claim 7, wherein:
the solid raw materials are formed by a process selected from the group consisting of physical vapor deposition (PVP) and chemical vapor deposition process (CVD); and
the deposition is upon a high heat resistant substrate selected from the group consisting of semiconductors, oxides, metals, ceramics, and polymer carbon related materials.

18. The composition of matter as defined in claim 7, wherein:
the solid raw materials are selected from the group consisting of non-polymeric and polymeric materials;
the non-polymeric and polymeric materials have at least one bonding link of a triple bond, a double bond, and a single bond, wherein:
the bonding link of two adjacent carbon atoms are selected from the group consisting of: CR₁═CR₂, —CR₁═CR₂—, and —CR₁R₂—CR₃R₄—; and
R₁, R₂, R₃, and R₄ are selected from the group consisting of:
a metal, H, alkyl, aryl, alkenes, alkenyl, —SH, —OH;
—COOH, —CO—, —CHO, —COOR;
SO₃H, —O—, —S—, —NO₂, —NH₂, —CN, —SO₂—, —SO₂C₂;
acid salts including but not limited to carbonium, iodonium, phosphonium, pyrylium, ammonium and the like;
—NR₁R₂ where R₁, R₂ is hydrogen, alkyl, aryl, and the like; and
a halogen (Cl, I, F, or Br).

19. The composition of matter as defined in claim 7, wherein the solid carbon source is a flammable solid selected from the group consisting of:
pine wood, pine wood resin, eucalyptus leaves, or eucalyptus oils;
calcium carbide or silicone carbide; jatropha curcas seed or jatropha curcas seed oil;
a cellulosic material including but not limited cloth, cotton, or paper;
vegetable oil, sun flower oil, pumpkin seed oil, lindseed oil, or the like;
rubber tree resin, rubber waste, palm wicker, paddy shell, or straw;
organometallic compounds including but not limited to acetyl acetonates of Ni, Co, Cu, Fe or the like;
diesel oil or kerosene oil;
solid fatty acids from a bird, a mammal, or a fish; and
combinations of the foregoing.

20. The composition of matter as defined in claim 19, wherein the flammable solid can be used alone or is blended with a liquid carbon source.

21. The composition of matter as defined in claim 1, wherein the solid metallic catalyst is selected from the group consisting of organometallic compounds, metal chelates, salts, acids, ester, oxides and the likes of metals and lanthanide, actinide elements described in the periodic chart including but not limited to Cr, Mn, Mg, Fe, Zn, Co, Ni, Pt, Pd, Ag, Au, Cu, Al, Si, Ti, V, Nb, Mo, Hf, Ta, and W.

22. The composition of matter as defined in claim 1, further comprising specific molecules for which an Ft-IR spectroscopic chart shows specific maximum peaks at wave number of 1065 cm⁻¹ and 1047 cm⁻¹.

23. The composition of matter as defined in claim 1, wherein the tube control agent is selected from the group consisting of:
a chemical having hydroxyl functional group —OH;
a thionyl functional group;
carbonyl functional groups of —CO including but not limited to pure CO, ester-COO—, carboxylic acid, or —COOH;
ether functional groups —O—;
alkoxides, hydrides and the like; and
a combination of at least one or more than one components among the foregoing compounds.

24. The composition of matter as defined in claim 23, wherein the tube control agent further comprises a tube forming enhancer having molecules that may carry other groups besides those of the tube control agent including but not limited to:
H, alkyl, aryl, alkenes, alkenyl, —SH;
—OH, —COOH, —CO—, —CHO, —COOR, or —SO₃H;
—O—, —S—, —NO₂, —NH₂, —CN, —SO₂—, or —SO₂Cl₂;
acid salts including but not limited to carbonium, iodonium, phosphonium, pyrylium, or ammonium;
—NR₁R₂, where R₁, R₂ is hydrogen, alkyl, aryl, and the like; and
a halogen including but not limited to Cl, I, F, or Br.

25. A composition of matter comprising carbon nano fibers which, when exposed to an X-Ray, exhibits a set of X-Ray diffraction pattern peaks appearing at different angles (Θ) comprising 2 theta (2Θ)=26.5°, 44.5° and 51.8°, wherein the carbon nano tubes are formed by heating, in a substantially oxygen free environment, solid raw materials comprising:
a solid carbon source;
a solid tube control agent; and
a solid metallic catalyst.

26. The composition of matter as defined in claim 25, wherein the carbon nano fibers are formed into a component of an electrical device selected from the group consisting of a Light Emitting Diode (LED), an electro catalyst, an electrode, and a fuel cell fuel penetration layer.

27. The composition of matter as defined in claim 25, wherein the carbon nano fibers are formed into a heat dissipation layer.

28. The composition of matter as defined in claim 27, wherein the heat dissipation layer is included in an electrical device selected from the group consisting of a Light Emitting Diode (LED), a semiconductor laser, a laser diode, and a nano transistor device.

29-31. (canceled)

32. The composition of matter as defined in claim 25, wherein the solid raw materials are combined with solid, liquid, and gas phase components.

33. The composition of matter as defined in claim 25, wherein the solid raw materials are composed of a single molecule with multifunctionality or are composed of more than one molecule with multifunctionality.

34. A composition of matter comprising carbon nano tubes which, when exposed to an X-Ray, exhibits a set of X-Ray diffraction pattern peaks appearing at different angles (Θ) comprising 2 theta (2Θ)=44.5° and 51.8°, wherein the carbon nano fibers are formed by heating, in a substantially oxygen free environment, solid raw materials comprising:
a solid carbon source;
a solid tube control agent; and
a solid metallic catalyst.

35. The composition of matter as defined in claim 34, wherein the carbon nano tubes are formed into a component of an electrical device selected from the group consisting of a Light Emitting Diode (LED), an electro catalyst, an electrode, and a fuel cell fuel penetration layer.

36. The composition of matter as defined in claim 34, wherein the carbon nano tubes are formed into a heat dissipation layer.

37. The composition of matter as defined in claim 36, wherein the heat dissipation layer is included in an electrical device selected from the group consisting of a Light Emitting Diode (LED), a semiconductor laser, a laser diode, and a nano transistor device.

38. (canceled)

39. The composition of matter as defined in claim 34, wherein the solid raw materials comprise at least one solid component that is a carbon source, a tube control agent, a combustible agent, and a metal related catalyst.

40. (canceled)

41. The composition of matter as defined in claim 34, wherein the solid raw materials are combined with solid, liquid, and gas phase components.

42. The composition of matter as defined in claim 34, wherein the solid raw materials are composed of a single molecule with multifunctionality or are composed of more than one molecule with multifunctionality.
